(19) United States
(12) Patent Application Publication
(10) Pub. No.: US 2026/0298009 A1
(43) Pub. Date: Oct. 1, 2026

(54) CLUTCH FOR MOTOR-DRIVEN HINGE

(71) Applicant: TURNA D.O.O., Sostanj (SI)

(72) Inventors: Peter Kolar, Polzela (SI); Ales Plesnik, Sostanj (SI)

(21) Appl. No.: 19/481,715

(22) PCT Filed: Nov. 3, 2024
(86) PCT No.: PCT/SI2024/050018

§ 371 Date: Nov. 5, 2025

(30) Foreign Application Priority Data
May 5, 2023 (SI) P-202300063

(51) Int. Cl. E05F 15/622

(52) U.S. Cl. CPC E05F 15/622; E05Y 2201/216; E05Y 2900/30

(57) ABSTRACT

The subject of invention is clutch for motor-driven hinge, solving technical problems of mechanical and manual opening/closing of appliance door (16), and protecting the appliance hinge against overloads and users from injury. Clutch for motor-driven hinge comprises at least gripping element (2), axis of gripping element (3), push element of clutch (5) and clutch bracket (1). Its components are attached to clutch bracket (1). Clutch bracket (1) is moved by motor (7) via motor drive (9). Gripping element (2) is movable about axis of gripping element (3). On one side, push element of clutch (5) applies force and generates torque about the axis of gripping element (3), whereas gripping element (2) applies pressure on hinge guide (10). When matching element of gripping element (4) and matching element of hinge guide (10) are joined, motor (7) via motor drive (9) moves the clutch for motor-driven hinge which moves hinge guide (10).

### FIELD OF TECHNOLOGY

Motor-driven opening and closing of appliance door; door closing hinge; door hinge clutch, clutch for motor-driven hinge, protecting the hinge against overloading, protecting the user against automatic door opening.

### TECHNICAL PROBLEM

Appliances in industrial or domestic use are becoming increasingly sophisticated. In order to ensure competitiveness on the market, increasingly improved appliances must be manufactured for reasonable costs, and appropriate components must be ensured for the assembly of such appliances, the manufacturing or purchasing costs of which should allow their installation into the product.

With more sophisticated kitchen appliances, such as stoves, ovens, dishwashers and refrigerator and freezer units, hinges must be installed to:
ensure a motor-driven opening and closing of the door;
ensure a manual opening and closing of the door;
ensure the required force though the entire area of door opening, since the doors on these appliances have a rather large mass due to their dimensions;
ensure that the opening or closing of the door is stopped if an obstacle is encountered during movement, thereby protecting the door hinge and the user from injury;
hinges must have small dimensions, long lifetime and be affordable, while their possible servicing must be as simple as possible.
hinges must ensure that installation is as easy as possible and, if possible, that several components are already installed during the manufacture of appliances.

### STATE OF THE ART

Hinges for motor-driven opening and closing of doors are generally well known, since they have been on the market for a long time. With known solutions, when installing the motor-driven hinges, the door hinge, including any associated door drive elements, is installed into the appliance during the assembly of the oven structural elements due to its size.

As a result, the installation of hinges requires more space in the walls of the appliance. In the case of heating or cooling appliances, it is sensible to insulate the walls of the appliance. When hinges with all the associated elements are installed into the appliance walls, the thickness of the insulation in the appliance walls is limited. If space for installation cannot be gained by reducing the insulation thickness, the internal or working volume of the appliance is reduced.

With known state of the art, the door of the appliance, when opening or closing, does not stop as soon as it encounters an obstacle during its movement, forcing continued movement for a certain time interval until the electronics detect that the hinge cannot move. During this time, the hinge continues to apply full force, which may result in damage to the hinge or injury to the user.

The device according to the invention provides a solution to the technical deficiencies described, which occur with motor-driven door hinges.

### DESCRIPTION OF NEW INVENTION

The subject of the invention is a clutch for motor-driven hinge, which solves the technical problems of mechanical and manual opening and closing of the door of the appliance, while protecting the hinge of the appliance against overloads and the user of the appliance from injury.

The clutch for motor-driven hinge comprises at least a gripping element, an axis of the gripping element, a push element of the clutch and a clutch bracket, whereby the clutch components are attached to the clutch bracket. The clutch bracket is moved by the motor via the motor drive.

The gripping element is movable about the axis of the gripping element. On one side, the push element of the clutch applies force on the gripping element and generates torque about the axis of the gripping element. Consequently, the gripping element applies pressure on the hinge guide on the other side via the matching element of the gripping element. The surface of the hinge guide contains the matching element of the hinge guide, whereby its shape coincides with the shape of the matching element of the gripping element in such a way that one of the matching elements is recessed into the other.

When the matching element of the gripping element and the matching element of the hinge guide are joined, the motor moves the clutch for motor-driven hinge via the motor drive, and the clutch for motor-driven hinge moves the hinge guide, thereby allowing the motor-driven opening or closing of the door via the hinge latch.

The push element of the clutch, preferably constructed as a spring, transmits the force to the gripping element or the matching element of the gripping element which moves along the hinge guide.

The matching element of the gripping element can be an independent element and is preferably constructed as a clutch roller. In the exemplary embodiment, the clutch roller rolls on the hinge guide.

A support roller is constructed under the hinge guide, preferably in the vicinity of the gripping element. The support roller is mounted on the clutch bracket, preferably with at least one support rivet. The support roller generates a reaction force in the opposite direction of the force of the clipping element, creating a force balance.

When the matching element of the gripping element is in a matching shape with the matching element of the hinge guide, the force of the gripping element constantly forces it into the centre of this matching shape. In the position described, the force of the motor can be transmitted to the hinge via the hinge guide and consequently the hinge moves with the entire clutch for motor-driven hinge.

The motor generates a force that is coaxial to the hinge force via a motor drive, preferably constructed as a threaded spindle.

The force of the motor is sufficient to overcome the force of the hinge and consequently move the hinge in both directions in normal operation or when no obstacle is present.

The force of manual movement or obstacle is the force generated when the user moves the door manually or when the door encounters an obstacle during a motorised movement.

The reaction force is the force acting against the force of the gripping element. The reaction force increases substantially when the force of manual door movement or obstacle is applied.

When the reaction force is greater than the force of the gripping element, the matching element of the gripping element, preferably constructed as a clutch roller, moves from the matching shape of the guide or from the matching element of the hinge guide. Depending on the direction of application of the increased reaction force, the matching element of the gripping element moves from the matching shape to the corresponding side of the hinge guide, as the clutch operates on both sides, both when closing and opening the door. Furthermore, in the appropriate position, the matching element of the gripping element coincides with the matching element of the hinge guide regardless of the direction of movement of the motor drive.

When the matching element of the gripping element is not in a matching shape, the force of the motor cannot be transmitted to the hinge guide and the force of the hinge guide cannot be transmitted to the motor.

The force of the gripping element applied on the hinge guide is sufficiently high to allow the force of the motor to be transmitted to the hinge without deactivating the clutch for motor-driven hinge.

At the same time, the force of the gripping element is sufficiently low to deactivate the clutch for motor-driven hinge when the door is manually moved or an obstacle is encountered, thus preventing damage to the motor or obstacle or injury to the user.

When the door is manually opened, the hinge is moved to the open position, while the motor and clutch for motor-driven hinge remain in the closed position, whereas the matching element of the gripping element is in contact with the rear part of the hinge guide, which is preferably constructed at an angle of inclination or is constructed as an inclined part of the hinge guide. When the matching element of the gripping element moves along this inclined part of the hinge guide, the gripping element moves as well, and the matching element of the gripping element follows the height of the hinge guide. In this position, due to the inclination of the hinge guide, a certain amount of force is also transferred from the hinge to the motor. Due to the small angle of inclination, this force is sufficiently low, so that it is not detected by the user and it cannot damage the motor.

When the door was opened by the motor and the door is manually closed by the user, the matching element of the gripping element is in contact with the flat part of the hinge guide or with the part of the hinge guide that is closer to the hinge latch. When the matching element of the gripping element moves in this area, the gripping element does not move and, consequently, the hinge force is not transmitted to the motor and the motor force is not transmitted to the hinge. Only the minimum force resulting from the friction during the movement of the components is transmitted.

The operation of the clutch for motor-driven hinge allows the hinge to be mounted separately in the appliance. Due to a disengageable link between the clutch for motor-driven hinge and the hinge, the hinge is mounted in the appliance separately from the bracket with the motor and the clutch for motor-driven hinge. First, the bracket with the motor and the clutch for motor-driven hinge is mounted in the appliance, after which the hinge is pushed into the clutch for motor-driven hinge by means of a linear motion. Due to the small angle of inclination of the inclined part of the hinge guide, the push force is sufficiently low to allow the assembler to push the hinge into place without using additional tools. The bracket with the motor and the clutch for motor-driven hinge is supplied in such a condition that when the hinge is pushed into place the fixing holes of the hinge body are aligned with the fixing holes of the mechanism bracket. When the fasteners, preferably the screws, are mounted through the mechanism bracket into the hinge body, the motor-driven hinge assembly is completed and the hinge is functional. The assembly is carried out without the need for additional tools or temporary locking elements.

The hinge body is the base of the hinge structure to which other components are attached and against which other components move. The hinge latch is connected to the hinge body by a swivel link which forms the pivot point of the door of the final appliance. Depending on the implementation of the hinge, the hinge latch and the hinge body are coupled to the oven body and door. The hinge lock can be connected to the hinge latch by a swivel link and allows the movement of the hinge to be blocked for mounting purposes.

The hinge link and the hinge guide are connected to the hinge latch and to each other by a swivel link and transmit the power of the hinge spring to the hinge latch. The power of the hinge spring generates torque about the latch pivot point, which balances the door at every operating angle, thus reducing the motor power required for motorised door closing. The spring stop plate transmits the power of the hinge spring to the hinge guide.

The hinge guide moves linearly along the hinge spring when the hinge latch rotates around its pivot point. The movement of the mechanism can occur when the user opens or closes the appliance door, generating torque which rotates the hinge latch around its pivot point and consequently causes a linear movement of the hinge guide. The movement of the mechanism can also occur when a certain linear force in the direction along the movement of the hinge guide is applied to the hinge guide, causing a rotary motion of the hinge latch. The hinge body is fixed to the mechanism bracket.

The clutch bracket is the base of the structure of the clutch for motor-driven hinge to which other components are attached and against which they move. The clutch bracket has a curved tab that activates the limit switch in the starting position, allowing the starting position of the mechanism to be recognised even after power outage. The clutch bracket and all the elements attached to it move linearly along the hinge spring. The force required to move the clutch bracket is transmitted from the motor by the motor drive, preferably constructed as a trapezoidal nut which is coupled to the clutch bracket. The motor is attached to the mechanism bracket via the motor bracket.

The essence of the invention is further explained below with the description of the embodiment and attached figures, whereby the figures are part of this patent application and show the following:

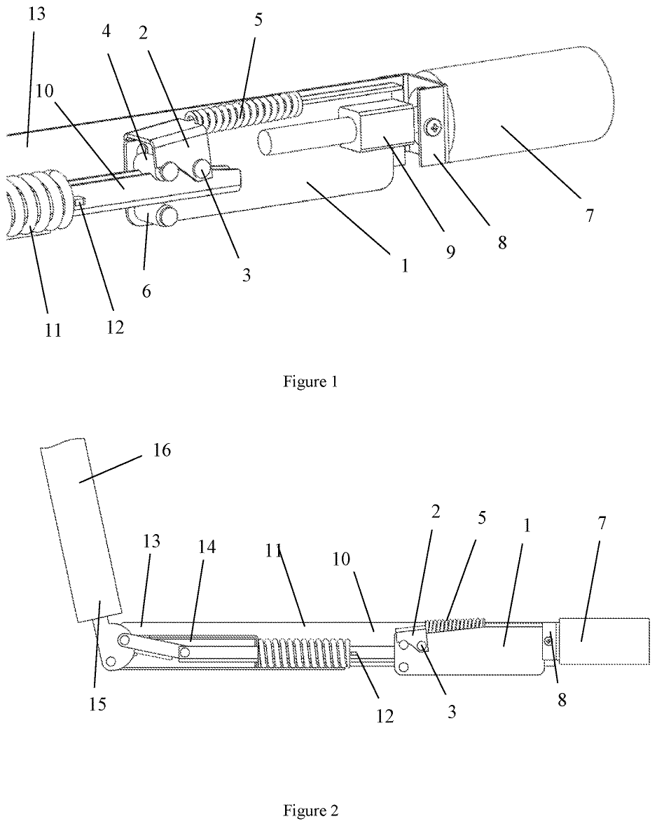

FIG. 1 shows a closed hinge with the clutch in the joined condition, the clutch bracket 1, the gripping element 2, the axis of the gripping element 3, the matching element of the gripping element 4, the push element of the clutch 5, the support roller 6, the motor 7, the motor bracket 8, the motor drive 9, the hinge guide 10, the hinge spring 11, the spring stop plate 12 and the mechanism bracket 13.

FIG. 2 shows a partially closed hinge with the clutch in the joined condition, the clutch bracket 1, the gripping element 2, the axis of the gripping element 3, the push element of the clutch 5, the motor 7, the motor bracket 8, the hinge guide 10, the hinge spring 11, the spring stop plate 12, the mechanism bracket 13, the hinge body 14, the hinge latch 15 and the door 16.

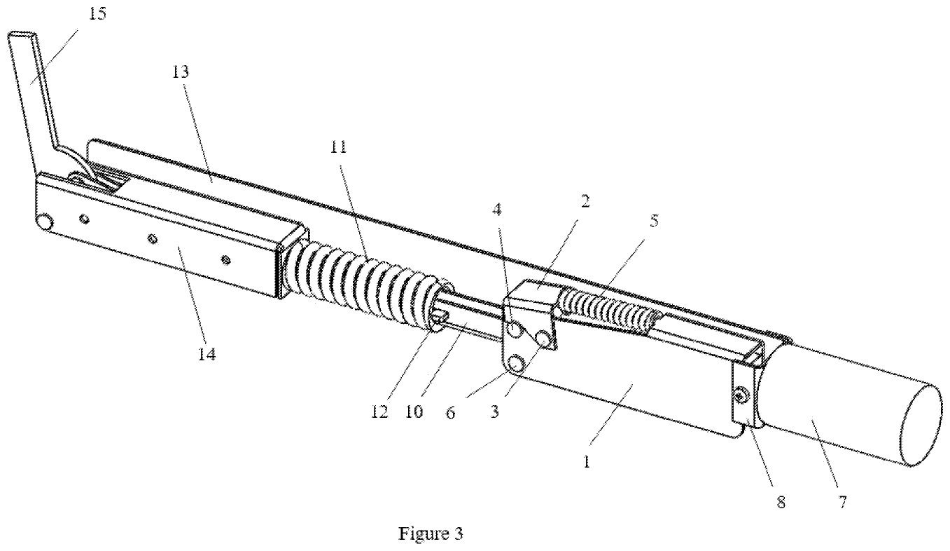

FIG. 3 shows a partially closed hinge with the clutch in the joined condition, the clutch bracket 1, the gripping element 2, the axis of the gripping element 3, the matching element of the gripping element 4, the push element of the clutch 5, the support roller 6, the motor 7, the motor bracket 8, the hinge guide 10, the hinge spring 11, the spring stop plate 12, the mechanism bracket 13, the hinge body 14 and the hinge latch 15.

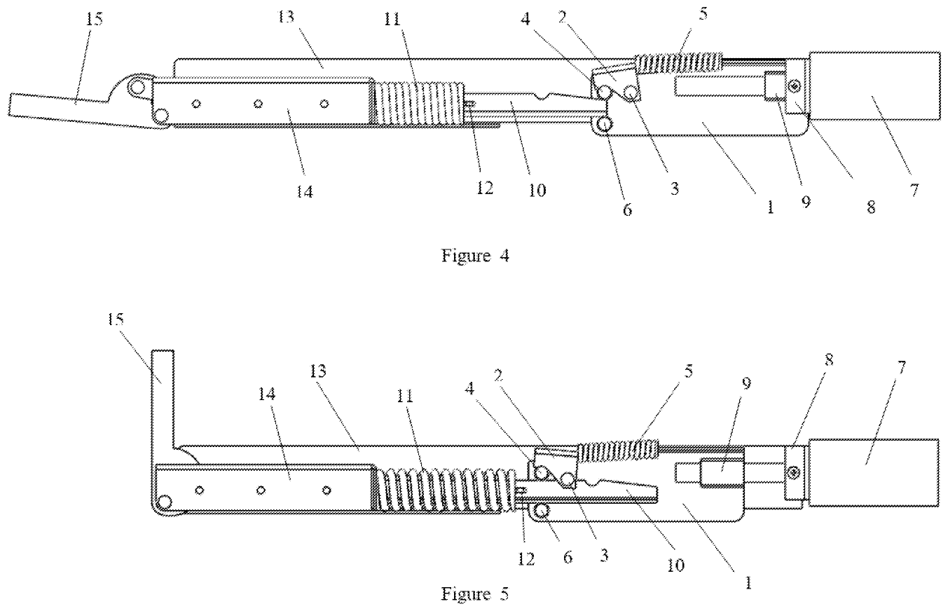

FIG. 4 shows a manually opened hinge with disengaged clutch in the closed position, the clutch bracket 1, the gripping element 2, the axis of the gripping element 3, the matching element of the gripping element 4, the push element of the clutch 5, the support roller 6, the motor 7, the motor bracket 8, the motor drive 9, the hinge guide 10, the hinge spring 11, the spring stop plate 12, the mechanism bracket 13, the hinge body 14 and the hinge latch 15.

FIG. 5 shows a manually closed hinge with disengaged clutch in the open position, the clutch bracket 1, the gripping element 2, the axis of the gripping element 3, the matching element of the gripping element 4, the push element of the clutch 5, the support roller 6, the motor 7, the motor bracket 8, the motor drive 9, the hinge guide 10, the hinge spring 11, the spring stop plate 12, the mechanism bracket 13, the hinge body 14 and the hinge latch 15.

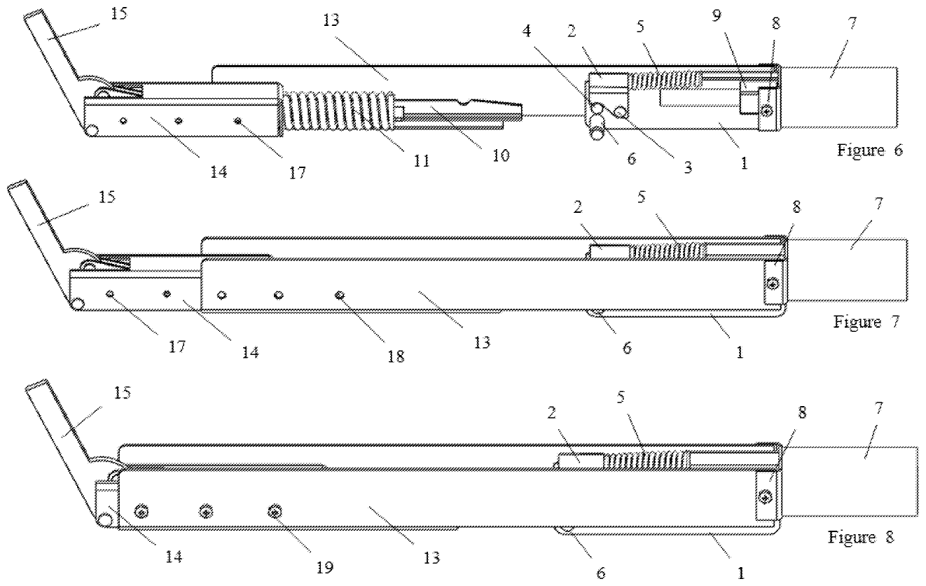

FIG. 6 shows a hinge in the delivery condition, an assembly of the mechanism bracket with motor and clutch in the delivery condition prior to installation in the appliance, the clutch bracket 1, the gripping element 2, the axis of the gripping element 3, the matching element of the gripping element 4, the push element of the clutch 5, the support roller 6, the motor 7, the motor bracket 8, the motor drive 9, the hinge guide 10, the hinge spring 11, the mechanism bracket 13, the hinge body 14, the hinge latch 15 and the fixing bore on the mechanism body 17.

FIG. 7 shows a hinge in the delivery condition, an assembly of the mechanism bracket with motor and clutch in the delivery condition prior to installation in the appliance, the clutch bracket 1, the gripping element 2, the push element of the clutch 5, the support roller 6, the motor 7, the motor bracket 8, the mechanism bracket 13, the hinge body 14, the hinge latch 15, the fixing bore on the mechanism body 17 and the fixing bore on the mechanism bracket 18.

FIG. 8 shows a hinge in the delivery condition, an assembly of the mechanism bracket with motor and clutch in the delivery condition after installation in the appliance, the clutch bracket 1, the gripping element 2, the push element of the clutch 5, the support roller 6, the motor 7, the motor bracket 8, the mechanism bracket 13, the hinge body 14, the hinge latch 15 and the hinge fastener 19.

### EXEMPLARY EMBODIMENT

In the exemplary embodiment, the gripping element 2 is attached to the clutch bracket 1 by a swivel link or axis of the gripping element 3. The matching element of the gripping element 4 is an independent part and is constructed as a clutch roller. The push element of the clutch 5, constructed as a clutch spring, is installed between the clutch bracket 1 and the gripping element 2, generating torque about the axis of the gripping element 3. The gripping element 2 transmits power to the matching element of the gripping element 4 in a direction perpendicular to the movement of the clutch bracket 1 and the movement of the hinge guide 10. The matching element of the gripping element 4 rolls on the hinge guide 10 and transmits the power of the push element of the clutch 5 to the hinge guide 10 in a direction perpendicular to the direction of movement of the hinge guide 10.

The support roller 6 is mounted on the clutch bracket 1 and creates support for the hinge guide 10. When the matching element of the gripping element 4 rolls on the surface of the hinge guide 10 outside the matching shape for the matching element of the gripping element 4, the force transmitted from the matching element of the gripping element 4 to the hinge guide 10 in the longitudinal direction is minimal.

When the matching element of the gripping element 4 is in the matching shape of matching element of the hinge guide, as a result of the inclination of the sides of the matching part, the force generated by the matching element of the gripping element 4 in the longitudinal direction of the hinge guide 10 is sufficiently high to transmit the movement of the clutch bracket 1 to the hinge guide 10, thus causing the movement of the hinge guide 10. The hinge guide 10 is therefore wedged between the matching element of the gripping element 4 and the support roller 6, forming a disengageable link between the clutch bracket 1 and the hinge guide 10, which disengages when the force in the longitudinal direction of the hinge guide 10 is sufficiently high to overcome the torque of the gripping element 2 generated by the push element of the clutch 5 in a direction perpendicular to the movement of the hinge guide 10.

All the elements are constructed in such way that the hinge guide 10 can move longitudinally in relation to the clutch bracket 1 and all the elements attached to it without collision. The hinge guide 10 can move along the clutch bracket 1 in both directions and consequently allows the clutch for motor-driven hinge to be disengaged in both directions.

The disengagement of the clutch of a motor-driven hinge is possible when the clutch bracket 1 is in motion and the hinge guide 10 is not in motion due to obstruction of the movement of the door or when the clutch bracket 1 is not in motion and the hinge guide 10 is in motion due to manual movement of the appliance door. When the clutch bracket 1 is in motion and the movement of the appliance door is not obstructed, the movement of the clutch for motor-driven hinge causes the movement of the hinge guide 10 and consequently the movement of the appliance door.

The clutch for motor-driven hinge thus allows the motorised movement of the door through the entire range of movement of the door 16, and protects itself against overloading in the event of an obstacle. It also protects the user of the appliance from injury, since the force of the motorised movement of the appliance door is limited and is conditional on the force of the push element of the clutch 5.

The clutch bracket 1 is the base of the structure of the clutch for motor-driven hinge to which other components are attached and against which they move. The clutch bracket 1 has a curved tab that activates the limit switch in the starting position, allowing the starting position of the mechanism to be recognised even after power outage.

The clutch bracket 1 and all the elements attached to it move linearly along the hinge spring 11. The force required to move the clutch bracket 1 is transmitted from the motor 7 by the motor drive 9, constructed as a trapezoidal nut which is coupled to the clutch bracket 1. The motor 7 is attached to the mechanism bracket 13 via the motor bracket 8.

The hinge body 14 is the base of the hinge structure to which other hinge components are attached and against which other components move. The hinge latch 15 is connected to the hinge body 14 by a swivel link which forms the pivot point of the door of the final appliance. Depending on the user's implementation of the hinge, the hinge latch 15 and the hinge body 14 are coupled to the oven body and door.

The hinge lock can be connected to the hinge latch 15 by a swivel link and allows the movement of the hinge to be blocked for mounting purposes. The hinge link and the hinge guide 10 are connected to the hinge latch 15 and to each other by a swivel link and transmit the power of the hinge spring 11 to the hinge latch 15. The power of the hinge spring generates torque about the pivot point of the latch 15, which balances the door at every operating angle, thus reducing the power of the motor 7 required for motorised door closing 16. The spring stop plate 12 transmits the power of the hinge spring 11 to the hinge guide 10.

The hinge guide 10 moves linearly along the hinge spring 11 when the hinge latch 15 rotates around its pivot point. The movement of the mechanism can occur when the user opens or closes the appliance door, generating torque which rotates the hinge latch 15 around its pivot point and consequently causes a linear movement of the hinge guide 10. The movement can also occur when a certain linear force in the direction along the movement of the hinge guide 10 is applied to the hinge guide 10, causing a rotary motion of the hinge latch 15. The hinge body 14 is fixed to the mechanism bracket 13.

The disengageable design of the clutch for motor-driven hinge allows easy installation into the final appliance. The assembly of the mechanism bracket 13, motor 7, motor bracket 8, limit switch and clutch bracket 1, and all the components attached to the clutch bracket 1 are supplied separately from the hinge assembly.

The mechanism bracket 13 is adapted to the requirements of the manufacturer of appliances and to the interior of the appliance. The assembly of the mechanism bracket 13 and all the aforementioned components is mounted in the appliance during the assembly of the appliance structure without the hinge.

Once the structure of the appliance is complete, a hinge is mounted from the front by simply pushing it through the opening in the front wall of the appliance. The inclination on the hinge guide 10 gradually lifts the gripping element 2, which is why the required push force is relatively small or sufficiently low to ensure manual assembly.

The assembly of the mechanism bracket 13 and the aforementioned components is supplied in the delivery position, whereby the clutch bracket 1 is in such a position that when the matching element of the gripping element 4 and the matching part of the hinge guide are in a matching shape, the hinge is in the ideal position for assembly, and the fixing bores on the hinge body 17 and the fixing bores on the mechanism bracket 18 are accessible for mounting the hinge with hinge fasteners 19.

It is self-evident that the above described invention can be also used in other particular form not changing the substance of the invention.

1. The clutch for motor-driven hinge, characterised in that it comprises at least a gripping element (2), an axis of the gripping element (3), a push element of the clutch (5) and a clutch bracket (1), whereby the components of the clutch for motor-driven hinge are attached to the clutch bracket (1).

2. The device according to claim 1, characterised in that the clutch bracket (1) is moved by the motor (7) via the motor drive (9).

3. The device according to claim 1, characterised in that the gripping element (2) is movable about the axis of the gripping element (3), whereby on one side, the push element of the clutch (5) applies force on it and generates torque about the axis of the gripping element (3), and consequently, the gripping element (2) applies pressure on the hinge guide (10) on the other side via the matching element of the gripping element (4).

4. The device according to claim 1, characterised in that the surface of the hinge guide (10) contains the matching element of the hinge guide, whereby its shape coincides with the shape of the matching element of the gripping element (4) in such a way that one of the matching elements is recessed into the other.

5. The device according to claim 1, characterised in that when the matching element of the gripping element (4) and the matching element of the hinge guide are joined, the motor (7) moves the clutch for motor-driven hinge via the motor drive (9), and the clutch for motor-driven hinge moves the hinge guide (10), thereby allowing the motor-driven opening or closing of the door (16) via the hinge latch (15).

6. The device according to claim 1, characterised in that the push element of the clutch (5) transmits the force to the gripping element (2) or the matching element of the gripping element (4) which moves along the hinge guide (10).

7. The device according to claim 1, characterised in that the push element of the clutch (5) is constructed as a spring.

8. The device according to claim 1, characterised in that the matching element of the gripping element (4) is an independent element and is constructed as a clutch roller which rolls on the hinge guide (10).

9. The device according to claim 1, characterised in that the support roller (6) is constructed under the hinge guide (10) in the vicinity of the gripping element (2), whereby the support roller (6) generates a reaction force in the opposite direction of the force of the clipping element (2), creating a force balance.

10. The device according to claim 1, characterised in that when the matching element of the gripping element (4) is in a matching shape with the matching element of the hinge guide (10), the force of the motor (7) is transmitted to the hinge via the hinge guide (10) and consequently the hinge moves with the entire clutch for motor-driven hinge.

11. The device according to claim 1, characterised in that the motor (7) generates a force that is coaxial to the hinge force via the motor drive (9).

12. The device according to claim 1, characterised in that the motor drive (9) is constructed as a threaded spindle.

13. The device according to claim 1, characterised in that when the reaction force is greater than the force of the gripping element (2), the matching element of the gripping element (4) moves from the matching shape of the hinge guide (10) or from the matching element of the hinge guide (10).

14. The device according to claim 1, characterised in that when the matching element of the gripping element (4) is not in a matching shape, the force of the motor (7) cannot be transmitted to the hinge guide (10) and the force of the hinge guide (10) cannot be transmitted to the motor (7).

15. The device according to claim 1, characterised in that the force of the gripping element (2) applied on the hinge guide (10) is sufficiently high to allow the force of the motor (7) to be transmitted to the hinge without deactivating the clutch for motor-driven hinge.

16. The device according to claim 1, characterised in that the force of the gripping element (2) is sufficiently low to deactivate the clutch for motor-driven hinge and prevent damage to the motor (7) when the door (16) is manually moved or an obstacle is encountered.

17. The device according to claim 1, characterised in that when the door (16) is manually opened, the hinge is moved to the open position, while the motor (7) and clutch for motor-driven hinge remain in the closed position, whereas the matching element of the gripping element (4) is in contact with the rear part of the hinge guide (10).

18. The device according to claim 1, characterised in that the rear part of the hinge guide (10) is constructed at an angle of inclination or is constructed as an inclined part of the hinge guide (10).

19. The device according to claim 1, characterised in that when the matching element of the gripping element (4) moves along the inclined part of the hinge guide (10), the gripping element (2) moves as well, and the matching element of the gripping element (4) follows the height of the hinge guide.

20. The device according to claim 1, characterised in that when the door (16) is opened by the motor (7) and the door (16) is manually closed by the user, the matching element of the gripping element (4) is in contact with the flat part of the hinge guide (10) or with the part of the hinge guide (10) that is closer to the hinge latch (15).

21. The device according to claim 1, characterised in that due to a disengageable link between the clutch for motor-driven hinge and the hinge, the hinge is mounted in the appliance separately from the mechanism bracket (13) with the motor (7) and the clutch for motor-driven hinge.

22. The device according to claim 1, characterised in that the mechanism bracket (13) with the motor (7) and the clutch for motor-driven hinge is first mounted in the appliance, after which the hinge is pushed into the clutch for motor-driven hinge by means of a linear motion.

23. The device according to claim 1, characterised in that the hinge body (14) is the base of the hinge structure to which other components are attached and against which other components move.

24. The device according to claim 1, characterised in that the hinge body (14) is fixed to the mechanism bracket (13).

25. The device according to claim 1, characterised in that the clutch bracket (1) is the base of the structure of the clutch for motor-driven hinge to which other clutch components are attached and against which they move.

26. The device according to claim 1, characterised in that depending on the direction of application of the increased reaction force, the matching element of the gripping element (4) moves from the matching shape to the corresponding side of the hinge guide (10), as the clutch operates on both sides, both when closing and opening the door.

27. The device according to claim 1, characterised in that when the motor drive (9) moves and the clutch is disengaged, the matching element of the gripping element (4) in the appropriate position coincides with the matching element of the hinge guide regardless of the direction of movement of the motor drive (9).
